(19) United States
(12) Patent Application Publication
(10) Pub. No.: US 2003/0133135 A1
(43) Pub. Date: Jul. 17, 2003

(54) Enhancing the readability of a data listing

(76) Inventor: Anthony L. Barrett, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/053,157

(22) Filed: Jan. 16, 2002

(51) Int. Cl. B41J 1/00; G06F 15/00

(52) U.S. Cl. 358/1.1; 358/1.15

(57) ABSTRACT

A data listing contains multiple data entries. The data listing is analyzed to determine the number of data entries in the data listing. If the data listing has at least N data entries, then an index mark is added to every Nth entry in the data listing. The data listing may be printed or displayed on a computing device, including the added index marks. In one implementation, N is five. The index marks may be symbols or other distinguishing characteristics added near the appropriate data entry. The data listing can be a printer menu hierarchy including multiple levels of data entries.

### TECHNICAL FIELD

The present invention relates to the modification of data listings, such as printer menu maps, to enhance readability of data contained in the listings.

### BACKGROUND

Printer technology continues to advance, resulting in commercially available printers having faster speed, increased print quality, and improved features. A wide range of printers are commercially available, ranging from relatively inexpensive “desktop” models with few features to more expensive “printing press” models that have many features and expandable options.

Many printers offer specific features that are implemented within the printer or implemented by an accessory device that is attached to the input or output of the printer. One or more of these optional accessory devices may be connected serially to perform various functions, such as binding documents, stapling documents, hole-punching documents, or depositing a document into an appropriate mailbox.

As printers support additional features, they typically utilize more configuration settings to control various printer operations related to these additional features. For example, a printer that supports multiple paper trays as input devices may include several configuration settings for each installed paper tray. These settings may include, the size of the paper (e.g., letter, legal, or A4) installed in each paper tray and the type of paper (e.g., plain, transparency, or letterhead) installed in each paper tray.

When a user of a printer contacts a customer support agent to assist with a printer problem, the user may be requested to provide various printer settings and configurations to assist the customer support agent in analyzing the printer problem. To locate the requested printer settings and configurations, the printer user may navigate through the printer's menu hierarchy using a control panel on the printer. The control panel typically includes one or more buttons to select commands or settings, and a display device to display various printer information, such as settings and available options. If the printer is coupled to a network, the user may be some distance from the printer, such that the user cannot simultaneously manipulate the printer control panel and talk to the customer support agent on the telephone. Thus, the user must write down the instructions provided by the customer support agent and attempt to follow the instructions without any live assistance of the customer support agent. Such a task is frustrating to the user and is not likely to produce the results desired by the customer support agent.

Some printers allow a user to print a menu map that identifies the entire menu hierarchy of the printer as well as any settings associated with each entry in the menu hierarchy. This feature allows the user of the printer to print a menu map for the particular printer and return to their telephone and discuss the various settings live with the customer support agent. However, the menu map for printers with many features and settings can be large, with twenty or more entries for a particular level in the menu map. Such a long list of settings increases the difficulty of locating a particular item in the list. For example, if the customer service agent asks the user to locate the sixteenth entry in a particular list of settings, the task is tedious and error-prone. Further, many entries in the list may include very similar information, thereby increasing the difficulty of locating the correct entry requested by the customer service agent.

The invention described herein addresses these problems by modifying the listing of information, such as a listing of various printer settings, to enhance the readability of the information contained in the listing.

### SUMMARY

A series of index marks are added to the listing of information to simplify the user's task of locating a particular entry in the listing. For example, index marks can be added to every fifth entry in the list, thereby allowing the user to easily count by five. Thus, to locate the sixteenth entry in the list, the user locates the first entry after the third index mark instead of counting through sixteen separate entries in the listing. Any number of index marks can be added to a particular listing. Typically, the index marks are spaced evenly (e.g., every Nth entry) throughout the listing.

In a particular embodiment, a printer menu hierarchy is identified. The printer menu hierarchy includes multiple levels of data entries. Each level of data entries is analyzed to determine the number of data entries on each level. For each level of data entries having at least N entries, an index mark is added to every Nth entry in the level of data entries.

In one embodiment, the printer menu hierarchy is printed, including the added index marks.

In another embodiment, a computer retrieves the printer menu hierarchy from a printer and displays the retrieved printer menu hierarchy, including the added index marks.

A particular implementation identifies a data listing containing multiple data entries. The data listing is analyzed to determine the number of data entries in the data listing. If the data listing has at least N data entries, then an index mark is added to every Nth entry in the data listing.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 is a block diagram showing pertinent components of an exemplary printer.

FIG. 2 illustrates an example printer coupled to communicate with a computer system.

FIG. 3 is a flow diagram illustrating a procedure for adding index marks to a menu hierarchy.

FIG. 4 is a flow diagram illustrating a procedure for generating a printer menu hierarchy that includes one or more index marks.

FIG. 5 illustrates an exemplary portion of a printer menu hierarchy containing multiple levels and multiple entries.

FIG. 6 illustrates an example portion (i.e., the printer configuration portion) of a printer menu hierarchy.

FIGS. 7A-7D illustrate exemplary menu hierarchy entries using different types of index marks.

### DETAILED DESCRIPTION

The present invention provides a modified data listing that includes index marks that simplify the task of identifying a particular entry in the data listing. The index marks may take a variety of different forms, as discussed herein, and allow a user to skip past groups of entries in the data listing instead of counting each individual entry in the listing. In a described implementation, index marks are associated with every fifth entry of a data listing.

When the data listing is a printer menu map that identifies the printer's menu hierarchy, the index marks are associated with every Nth entry (e.g., every fifth entry) at the same level in the menu hierarchy. This allows the user to skip through the entries at a particular level in groups of N, instead of counting each individual entry. This leads to a faster and more accurate identification of a particular entry in the data listing. For example, when a customer service agent asks a user to identify the twelfth entry in a list and determine the setting associated with that entry, the user can quickly find the twelfth entry by locating the entry that is two entries past the tenth entry. Since many people are proficient at counting by five (5, 10, 15, 20, and so on), they quickly locate the tenth entry, then count two entries farther down the listing. This approach is quicker and less likely to cause selection of the wrong entry than counting through twelve separate entries.

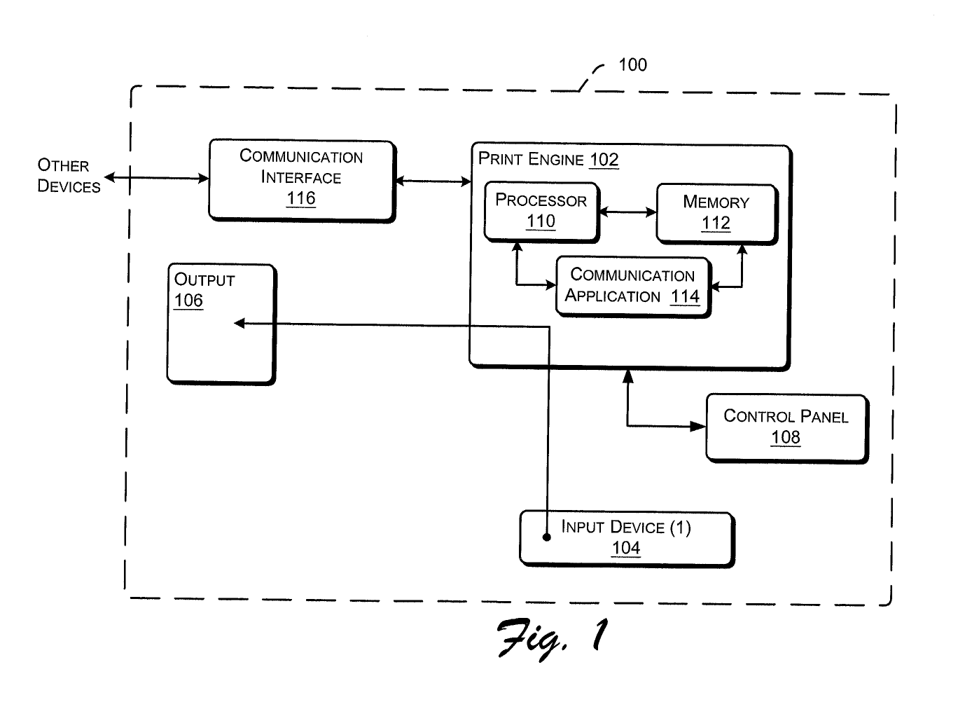

FIG. 1 is a block diagram showing pertinent components of an exemplary printer 100. As used herein, a printer refers to any type of device that can generate an image (e.g., a letter, a picture, a drawing, etc.) on any type of print media, such as paper, cardstock, plastic, or fabric. Example devices include impact printers, non-impact printers, digital copiers, analog copiers, facsimile machines, press machines, silk screen machines, etc. Printers can produce images on any of a wide variety of conventional print media (paper, plastic, fabric, etc.). However, for ease of discussion, printers are discussed herein in the context of printing on paper. A printer may also be referred to herein as a “printing device”.

Printer 100 includes a print engine 102 and an input device 104. The printer 100 also has at least one output device 106. During a printing operation, a sheet of paper is provided to print engine 102 from input device 104 or from a direct paper feed (e.g., an external direct-feed tray). As the sheet of paper passes through the print engine 102, the appropriate information is printed on the paper. The paper can be printed in any of a wide variety of conventional manners, such as a conventional laser printing process or a conventional inkjet printing process. After printing, the sheet of paper is output directly by print engine 102 to output 106, such as an output bin (or output tray), or other device capable of outputting the sheet of paper from the printer. Output 106 may be coupled to another device (not shown) that further processes the sheet of paper.

Input device 104 represents a variety of print medium sources and preprocessing devices. Example input devices include: a device with one or more paper trays for supplying one or more sizes or types of paper to print engine 102; a pre-processing device to put a “stamp” on each sheet of paper prior to printing (such as physically adding a stamp to the sheet of paper or adding a graphical image or text to the information for each page); a paper separating device that separates fan-folded media into separate sheets or to cut a sheet of paper from a roll of paper; a device to affix another piece of paper to the sheet for printing (e.g., a Post-It® Note); a hole punching device to punch hole(s) in each sheet of paper; or a scanning device, such as to obtain a serial number or other identifier from a sheet of paper to verify that pre-printed media is oriented correctly for printing.

Print engine 102, input device 104, and output device 106 can communicate with one another, transferring control information and data as necessary. Such communication may occur directly between two devices, or may be routed through print engine 102. Printer 100 includes additional components, such as a print head or other mechanism for producing the data to be printed on the sheet of paper in print engine 102.

Print engine 102 includes a processor 110, a memory/storage device 112, and a communication application 114. Processor 110 controls the transfer of paper through printer 100, including communication of information to the input device 104 and the output device 106. Processor 110 may also communicate information to other devices coupled to printer 100. Processor 110 may be any type of microprocessor or microcontroller capable of performing the operations necessary to control the operation of printer 100. Alternatively, processor 110 may be replaced by an ASIC (application specific integrated circuit) or other customized device capable of controlling the printer 100.

Memory 112 is a volatile and/or nonvolatile memory, such as a RAM (random access memory), a ROM (read only memory), a Flash EEPROM (electronically erasable programmable read only memory), or a magnetic or optical storage device. In one implementation, memory 112 includes RAM, ROM, and a hard disk drive. Memory 112 stores various information generated and/or used during the operation of the printer 100. For example, memory 112 may store a printer menu map that identifies the printer's menu hierarchy, including various index marks added to the menu map to assist a user in identifying a particular entry in the menu map. Although memory 112 is illustrated as being separate from processor 110, all or part of memory 112 may be incorporated into processor 110.

Print engine 102 also contains communication application 114, which may be stored in memory 112 or another storage device. Communication application 114 is executed by processor 110 or another processor (not shown) in printer 100. Communication application 114 allows printer 100 to communicate with other devices, such as other printers, computing devices, web servers, and the like. Printer 100 may be coupled to a network, thereby allowing other devices on the network to communicate with printer 100 via communication application 114.

In an alternate embodiment, communication application 114 is not located in print engine 102. For example, communication application 114 may be part of a separate module in the printer that includes a processor and a memory or other storage device.

Printer 100 also includes a control panel 108, which includes one or more buttons and a display screen. The buttons allow printer users to navigate through menus or option lists and select a desired option or setting. The display screen displays various menu entries, printer settings, and options available to the user. Additionally, the display screen of control panel 108 may display the current status of the printer, including warnings or error messages (such as a low toner warning or a paper jam error).

A communication interface 116 is coupled to the print engine 102 and allows the print engine to communicate with other devices, such as other printers, computers or other media processing devices (e.g., staplers, binders, or sorters) coupled to the printer 100. In a particular embodiment, communication interface 116 includes a network interface that permits communication between print engine 102 and other devices coupled to a common network. In other embodiments, communication interface may communicate via a parallel connection, a serial connection, a universal serial bus (USB) connection, or a wireless (e.g., infrared or radio frequency) connection. Although the communication interface 116 is illustrated in FIG. 1 as a separate component, in alternate embodiments, the communication interface 116 is integrated into the print engine 102. A particular printer may include any number of communication interfaces using any type of communication medium and any communication protocol.

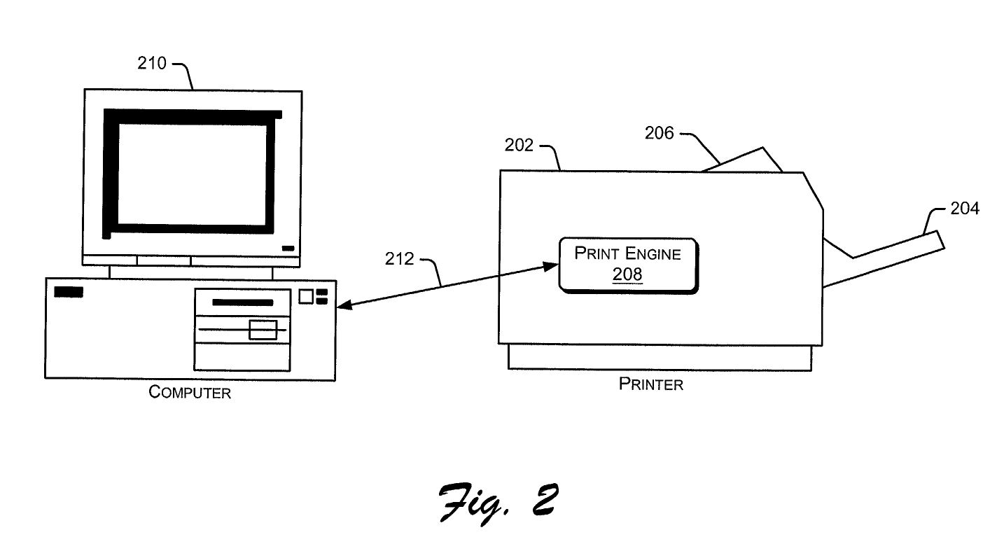

FIG. 2 illustrates an example printer 202 coupled to communicate with a computer system 210. Printer 202 includes an input tray 204, an output bin 206, and a print engine 208. Print engine 208 is similar to print engine 102 discussed above with respect to FIG. 1. Additionally, other input devices (not shown) and/or output devices may be coupled to or attached to printer 202. Print engine 208 communicates with computer system 210 via a communication link 212. Communication link 212 may be a wired or wireless link using any type of communication medium and using any communication protocol. In one implementation, communication link 212 is a network link that allows multiple computer systems to share printer 202.

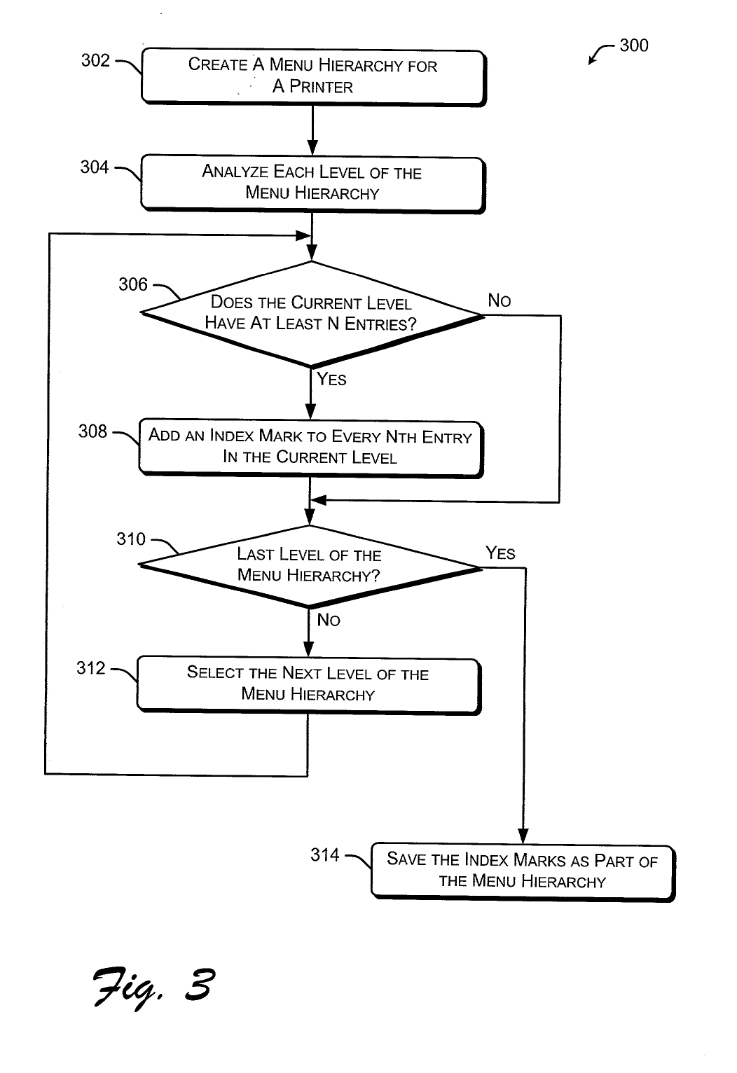

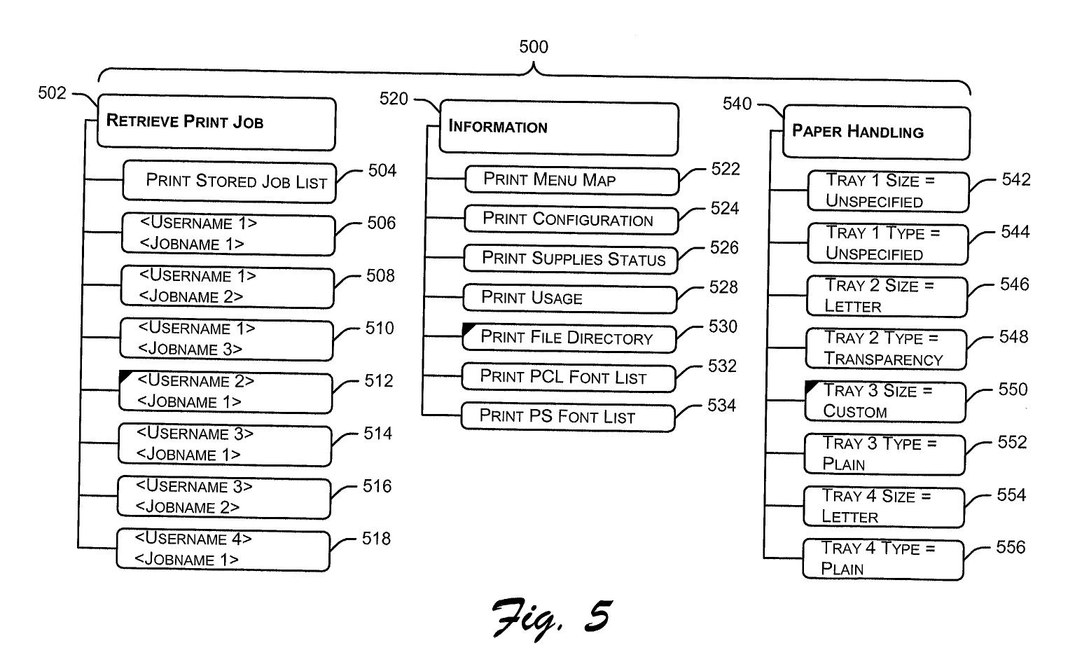

FIG. 3 is a flow diagram illustrating a procedure 300 for adding index marks to a menu hierarchy. Initially, a menu hierarchy is created for a particular printer (block 302). Next, the procedure analyzes each level in the menu hierarchy to determine the number of entries at each level of the hierarchy (block 304). A level in the menu hierarchy refers to all entries on the same level of the hierarchy. Referring briefly to FIG. 5, entry 502 is at one level in the hierarchy tree while entries 504-518 are all at a second level in the hierarchy tree. Similarly, entry 520 is at a particular level in the menu hierarchy and entries 522-534 are all at a different level in the menu hierarchy. Additional details regarding the menu hierarchy are provided below.

Referring back to FIG. 3, the procedure 300 determines whether the current level has at least N entries (block 306). In a particular embodiment, block 306 determines whether each level as at least five entries. If the current level of the menu hierarchy has at least N entries, an index mark is added to every Nth entry in the current level of the menu hierarchy (block 308). The current level of the menu hierarchy is the level currently being analyzed by procedure 300. If the current level of the menu hierarchy does not have at least N entries, index marks are not added to those entries.

The procedure then determines whether the current level is the last level in the menu hierarchy (block 310). If not, the procedure 300 selects the next level in the menu hierarchy for analysis (block 312) and returns to block 306 to determine whether the next level has at least N entries. If the current level is the last level in the menu hierarchy, the procedure branches from block 310 to block 314, which saves the index marks as part of the menu hierarchy. The index marks are stored in a non-volatile storage mechanism, such as a hard disk drive, a ROM, or a non-volatile RAM. Once the index marks are saved, they can be displayed and/or printed along with the menu hierarchy to assist a user in locating a particular entry in the menu hierarchy. The index mark information can be stored on a local computer or a remote system, such as a web server at a different geographic location.

In a particular embodiment, the index mark information is not stored permanently. Instead, the index marks are generated when needed (e.g., when generating a printer menu map) using a procedure similar to procedure 300 discussed above. A particular printer menu map may be dynamic such that the length and content of the menu map changes based on, for example, changes to the printer configuration, changes to installed options, previous menu selections, and other factors. In another embodiment, certain index marks are stored while other index marks are generated when needed.

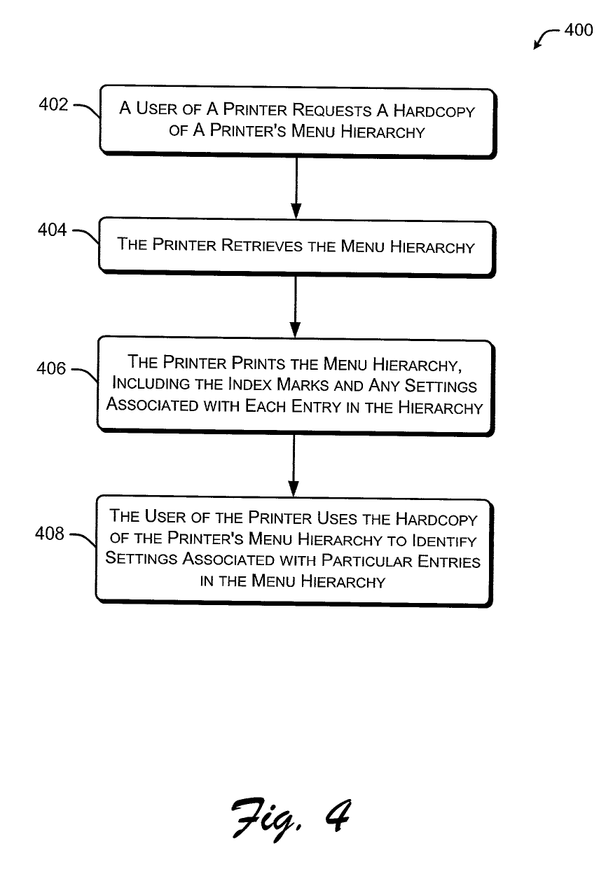

FIG. 4 is a flow diagram illustrating a procedure 400 for generating a printer menu hierarchy that includes one or more index marks. Initially, a user of a printer requests a hardcopy (i.e., a printed copy) of a printer's menu hierarchy (block 402). For example, a user may request a hardcopy of the menu hierarchy prior to contacting a customer support agent regarding a problem with the printer. This request for a hardcopy of the printer's menu hierarchy can be entered using the control panel of the printer or using an application program on the user's computer. Alternatively, the application program may be located on a remote computer (such as a server), a cellular phone, personal digital assistant (PDA) or other device.

A user may request a locally or remotely printed copy (or electronic copy) of a menu map using a program such as JetAdmin or WebJetAdmin, available from Hewlett-Packard Company of Palo Alto, Calif. These applications allow the user to see what's visible on the printer's control panel and remotely “press” any buttons or keys on the control panel as if the user was physically pressing the buttons or keys on the control panel.

The printer then retrieves the requested menu hierarchy (block 404). The menu hierarchy is printed by the printer such that the index marks and any settings associated with each entry are shown on the printed menu hierarchy (block 406). Finally, the user of the printer is able to use the hardcopy of the printer's menu hierarchy to identify various settings associated with particular entries of the menu hierarchy (block 408).

FIG. 5 illustrates an exemplary portion 500 of a printer menu hierarchy containing multiple levels and multiple entries. FIG. 5 illustrates three entries 502, 520, and 540 of the menu hierarchy that represent primary menu options (e.g., a highest level of menu choices). Each entry 502, 520, and 540 is at the same level of the hierarchy and has multiple associated entries at a sub-level of the menu hierarchy. For example, entry 502 (Retrieve Print Job) has eight associated entries 504-518 in a sub-level. Each of the eight entries 504-518 are related to the Retrieve Print Job function. All eight entries 504-518 are on the same level of the hierarchy (i.e., the same sub-level). For example, entry 504 prints a listing of all stored print jobs and entries 506-518 identify particular print jobs that are stored in a storage mechanism in the printer or other device. As shown in FIG. 5, entry 512 (the fifth entry in the sub-level) has an index mark for easy identification.

Entry 520 (Information) has seven associated entries 522-534 in a sub-level. Each of the seven entries 522-534 are on the same level of the menu hierarchy and are related to various printer information. For example, entry 522 prints a menu map of the printer's menu hierarchy and entry 528 provides various printer usage information. In this example, each entry 522-534 begins with “Print”, which can make counting of the individual entries difficult and error-prone. Such counting is difficult because the beginning of each entry is identical to the beginning of the other entries—only the later part of each entry is different. The fifth entry (530—Print File Directory) in the sub-level under entry 520 includes an index mark, which simplifies location of a particular entry by the user.

Entry 540 (Paper Handling) has eight associated entries 542-556 in a sub-level. Each of the seven entries 542-556 are on the same level of the menu hierarchy and are related to various paper handling settings. For example, entry 546 identifies the paper size installed in tray 2 of the printer and entry 548 identifies the type of paper installed in tray 2. In this example, each entry 542-556 begins with “Tray”, which, without index marks, adds to the difficulty of counting individual entries in the list. To simplify identification of particular entries in the list, the fifth entry (550—Tray 3 Size) in the sub-level under entry 540 includes an index mark.

As shown in FIG. 5, the fifth entry at each level includes an index mark. For example, entry 512 is the fifth entry under Retrieve Print Job 502, entry 530 is the fifth entry under Information 520, and entry 550 is the fifth entry under Paper Handling 540. As discussed above, these index marks simplify a user's task of locating a particular entry in a list of multiple entries.

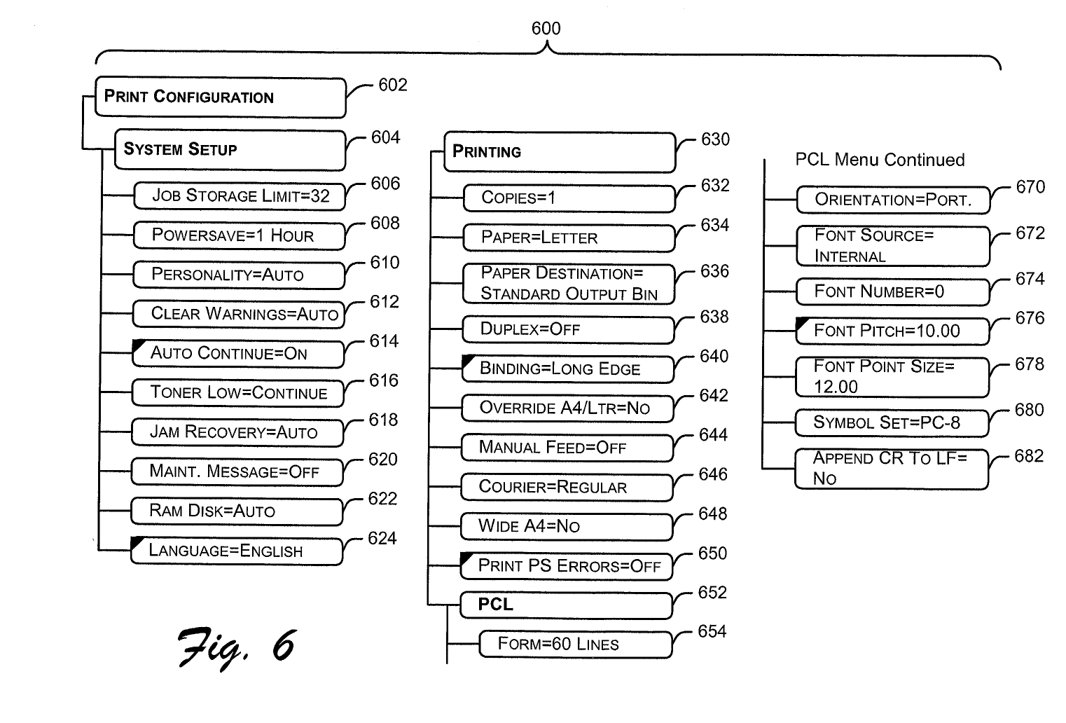

FIG. 6 illustrates an example portion 600 (i.e., the printer configuration portion) of a printer menu hierarchy that illustrates several levels of the hierarchy. Entry 602 (Print Configuration) is the highest level entry shown in FIG. 6. Entries 604 (System Setup) and 630 (Printing) are sub-levels located one level below entry 602. Entry 604 has ten associated entries 606-624 in a sub-level. Each of the ten entries 606-624 are on the same level of the menu hierarchy and are related to various system setup parameters. For example, entry 606 (Job Storage Limit) identifies the maximum number of print jobs that can be stored in the printer simultaneously. To simplify identification of entries in the list, the fifth entry 614 (Auto Continue) and the tenth entry 624 (Language) in the sub-level under entry 604 include an index mark.

Entry 630 (Printing) has eleven associated entries 632-652 in a sub-level. Each of the eleven entries 632-652 are on the same level of the menu hierarchy and are related to various printing parameters. For example, entry 638 (Duplex) identifies whether duplex printing has been enabled. To simplify identification of entries in this list, the fifth entry 640 (Binding) and the tenth entry 650 (Print PS Errors) in the sub-level under entry 630 include an index mark. Thus, if a user is attempting to locate the sixth entry in the list, they can quickly identify the entry by looking for the first entry after the first index mark. This process is faster, easier and less likely to produce an improper identification than counting through six individual entries in the list.

Entry 652 (PCL) has eight associated entries 654-682 in a sub-level. Each of the eight entries 654-682 are on the same level of the menu hierarchy and are related to various PCL (Printer Control Language) settings. For example, entry 678 (Font Point Size) identifies the point size of the selected font currently used by the printer. To simplify identification of entries in this list, the fifth entry 676 (Font Pitch) in the sub-level under entry 652 includes an index mark. The index marks also help avoid possible confusion as to what level (or sub-level) with which a particular entry is associated. For example, a user may not notice that entry 654 is the first entry of a different sub-level (a sub-level under entry 652). In this situation, the user may count entry 654 as the twelfth entry under entry 630 instead of the first entry under entry 652.

Although particular printer menu examples are described having specific numbers of entries (such as seven, eight, ten or eleven), a particular printer menu may have any number of entries. Further, the examples shown in FIG. 5 and FIG. 6 include index marks associated with every fifth entry in a particular level or sub-level. In alternate embodiments, the index marks may be placed at any interval (e.g., every Nth entry).

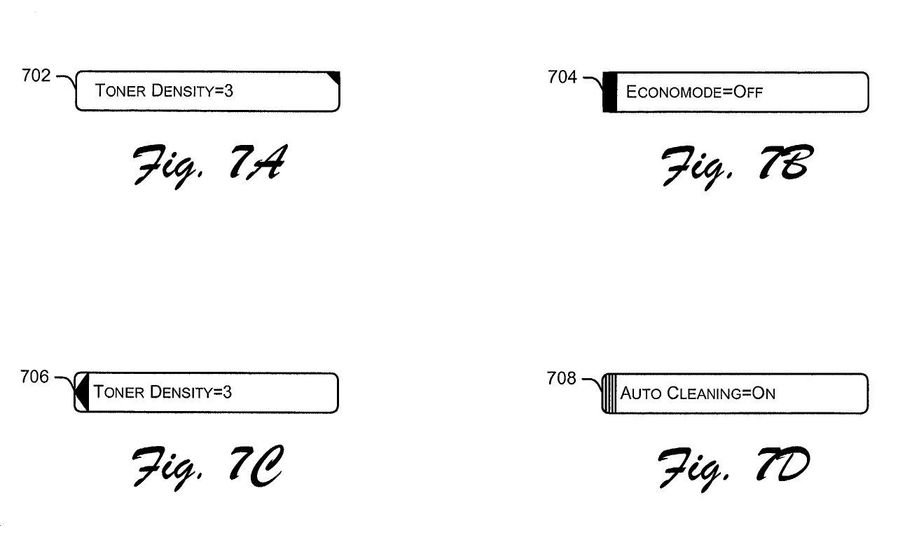

FIGS. 7A-7D illustrate exemplary menu hierarchy entries using different types of index marks. An index mark may be any symbol (e.g., an alphanumeric character), geometric shape (e.g., triangle, rectangle or diamond), spacing (e.g., double spacing), or other characteristic that is distinguishable from the content of the data entries. Additionally, a different font or font treatment (e.g., italics, bold or underline) may be used as an index mark. FIG. 7A illustrates a menu entry 702 with a triangular-shaped index mark in the upper right corner of the entry. This index mark is similar to the index marks shown in FIG. 5 and FIG. 6, but located in a different corner of the entry. In alternative embodiments, the triangular index mark may be placed in any corner or anywhere on any of the sides of the entry. Further, the index mark may take on any shape and its appearance may be solid (as shown), hollow or shaded.

FIG. 7B illustrates a menu entry 704 with a rectangular-shaped index mark along the left side of the entry. FIG. 7C illustrates a menu entry 706 with a larger triangular-shaped index mark and FIG. 7D illustrates a menu entry 708 with a series of vertical bars along the left edge of the entry.

The example index marks illustrated in the figures and discussed herein are for purposes of illustration. It will be appreciated that any number of different shapes and symbols of different sizes and locations or other distinguishing characteristics may be used to mark a particular entry. Further, a particular embodiment may include multiple index marks (including multiple types of index marks).

As shown in the various examples, the index marks do not overlap or otherwise interfere with the user's ability to read the information provided by each entry. By placing the index marks along an edge of each entry, the user can quickly locate the index marks yet still read all of the information provided in the desired entry.

Although particular examples are discussed herein with respect to a printer's menu map, similar index marks can be used with any listing of data. These index marks are particularly useful where a user is required to find a particular entry among a large number of entries.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
identifying a printer menu hierarchy, wherein the printer menu hierarchy includes multiple levels of data entries;
analyzing each level of data entries to determine the number of data entries associated with each level; and
for each level of data entries having at least N data entries, adding an index mark to every Nth data entry in the level of data entries.

2. A method as recited in claim 1 further comprising printing the printer menu hierarchy, including the added index marks.

3. A method as recited in claim 1 wherein N is five.

4. A method as recited in claim 1 wherein the printer menu hierarchy is stored in a printer associated with the printer menu hierarchy.

5. A method as recited in claim 1 wherein the printer menu hierarchy is stored remotely from a printer associated with the printer menu hierarchy.

6. A method as recited in claim 1 wherein the method is performed in response to a request to generate the printer menu hierarchy.

7. A method as recited in claim 1 further comprising:
retrieving the printer menu hierarchy from a printer using a computer coupled to the printer; and
displaying the retrieved printer menu hierarchy using the computer, wherein the displayed printer menu hierarchy includes the added index marks.

8. A method as recited in claim 1 wherein the data entries in the printer menu hierarchy include information related to printer settings.

9. A method as recited in claim 1 wherein the index mark is a distinguishing characteristic applied to appropriate data entries.

10. A method as recited in claim 1 wherein the index mark is a symbol added to appropriate data entries.

11. A method comprising:
identifying a data listing containing a plurality of data entries;
analyzing the data listing to determine the number of data entries in the data listing; and
if the data listing has at least N data entries, then adding an index mark to every Nth data entry in the data listing.

12. A method as recited in claim 11 further comprising printing the data listing, including the added index marks.

13. A method as recited in claim 11 further comprising:
retrieving the data listing; and
displaying the retrieved data listing on a computer, wherein the displayed data listing includes the added index marks.

14. A method as recited in claim 11 wherein N is five.

15. A method as recited in claim 11 wherein the index marks are symbols added proximate the appropriate data entry.

16. A printer comprising:
a processor configured to communicate with a storage device in the printer and to communicate with other devices coupled to the printer; and
a storage device coupled to the processor, the storage device containing a printer menu hierarchy associated with the printer, and wherein the printer menu hierarchy includes a plurality of data entries and an index mark associated with every Nth data entry in the plurality of data entries.

17. A printer as recited in claim 16 wherein the processor is further configured to print the printer menu hierarchy, including the index marks.

18. A printer as recited in claim 16 wherein the storage device is a non-volatile memory device.

19. A printer as recited in claim 16 wherein the storage device is a hard disk drive.
